(19) United States
(12) Patent Application Publication
(10) Pub. No.: US 2020/0372817 A1
(43) Pub. Date: Nov. 26, 2020

(54) METHOD AND SYSTEM FOR PROMPTLY CONNECTING A KNOWLEDGE SEEKER TO A SUBJECT MATTER EXPERT

(71) Applicant: Wisdom Cafe Inc., Yorba Linda, CA (US)

(72) Inventors: Deanna Gilmore, Yorba Linda, CA (US); Phillip Shipman, Yorba Linda, CA (US)

(21) Appl. No.: 16/947,521

(22) Filed: Aug. 5, 2020

Related U.S. Application Data
(60) Provisional application No. 62/883,482, filed on Aug. 6, 2019.

(51) Int. Cl. G09B 5/12; H04N 7/14; G06Q 30/02; G09B 5/14

(52) U.S. Cl. CPC G09B 5/125; G09B 5/14; G06Q 30/0284; H04N 7/147

(57) ABSTRACT

A computer system for promptly connecting a knowledge seeker to an expert having: a database having a first section adapted to receive and store data associated with the knowledge seeker and a second section adapted to receive and store data associated with the expert; a server having a processor and an application for promptly connecting the knowledge seeker to the expert comprising processor-executable instructions stored on a non-transitory processor-readable medium that when executed by the processor enables the computer system to perform operations, such as receiving and sending the profile data and expert request data associated with the knowledge seeker and profile data associated with the expert to the database; matching the expert request data to the profile data of the expert who is logged in at that time; allowing the knowledge seeker to select a desired expert; and connecting the knowledge seeker to the expert in a session call.

### CROSS-REFERENCE TO RELATED APPLICATIONS

This application claims the benefit of U.S. Provisional Application No. 62/883,482, filed Aug. 6, 2019, which is hereby incorporated by reference, to the extent that it is not conflicting with the present application.

### BACKGROUND OF INVENTION

### 1. Field of the Invention

The invention relates generally to connecting knowledge seekers to subject matter experts, and more specifically to connecting knowledge seekers to subject matter experts promptly for learning sessions.

### 2. Description of the Related Art

Currently, individuals do not have immediate access to subject matter experts specializing in answering subject specific information within the individual knowledge seeker's aptitude. Typically, when someone is looking for a subject matter expert or educator in a specific subject, they must research tutors or experts and schedule a session in order to provide the answers they desired. However, this is not an immediate connection, the knowledge seeker has to wait until the expert is available, and then has to schedule a learning session. A knowledge seeker usually wants the information immediately, thus having to wait for an expert may lead to the information not being desired anymore.

Furthermore, subject matter expert matching services typically do not verify the experts, which may lead to poor teaching quality. Additionally, knowledge seekers each have their own preferred learning method ranging from visual, auditory, physical, or a combination thereof. Current subject matter expert matching services do not take into account these differences in learning methods.

Therefore, there is a need to solve the problems described above by proving a system and method for rapidly connecting knowledge seekers to subject matter experts.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a system for connecting knowledge seekers and subject matter experts is provided. The computer system for promptly connecting a knowledge seeker to an expert having: a database having a first section adapted to receive and store data associated with the knowledge seeker and a second section adapted to receive and store data associated with the expert; a server having a processor and an application for promptly connecting the knowledge seeker to the expert comprising processor-executable instructions stored on a non-transitory processor-readable medium that when executed by the processor enables the computer system to perform operations, such as receiving and sending the profile data and expert request data associated with the knowledge seeker and profile data associated with the expert to the database; matching the expert request data to the profile data of the expert who is logged in at that time; allowing the knowledge seeker to select a desired expert; and connecting the knowledge seeker to the expert in a session call. Thus, an advantage is having a well-matched subject matter expert readily available for the knowledge seeker. Another advantage is the knowledge seeker is able to request a subject matter expert with their desired qualifications.

In another aspect, a method for connecting knowledge seekers and subject matter experts is provided. The method for immediately connecting a knowledge seeker to a subject matter expert comprising the steps of receiving and sending the data associated with the knowledge seeker and data associated with the subject matter expert to the database; wherein the data associated with the knowledge seeker comprises profile data provided by the knowledge seeker when registering with the application and expert request data including subject matter, target budget, and desired qualifications of the subject matter expert; wherein data associated with the subject matter expert comprises profile data provided by the subject matter expert when registering with the application including qualifications and government issued identification; checking in real time the background of the subject matter expert after receiving the government issued identification; confirming the identity of the subject matter expert by a live demonstration using a camera of a computer of the subject matter expert; setting a service fee per unit of time for the subject matter expert based on the subject matter expert's qualifications; after receiving the expert request data from the knowledge seeker, matching the expert request data to the profile data of the subject matter expert who are logged in at that time; displaying at least one or more profiles of matching subject matter experts to the knowledge seeker; allowing the knowledge seeker to select a desired subject matter expert from the displayed subject matter experts; and connecting the knowledge seeker to the subject matter expert in a secure session call. Thus, an advantage is having verified subject matter experts available any time the knowledge seeker desires a session for tutoring or homework help. Another advantage is the knowledge seeker is able to select the subject matter expert that is most tailored to their needs from a list of already compatible subject matter experts.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates a diagrammatic view of the user's experiences while using the application for prompt session connection, according to an aspect.

FIG. 2 illustrates the application's initiation flow chart, according to an aspect.

FIG. 3 conceptually illustrates a user welcome interface of the method and system for connecting knowledge seekers and subject matter experts, according to an aspect.

FIG. 4 conceptually illustrates a student registration interface of the method and system for connecting knowledge seekers and subject matter experts, according to an aspect.

FIG. 5 conceptually illustrates a subject matter expert registration interface of the method and system for connecting knowledge seekers and subject matter experts, according to an aspect.

FIG. 6 conceptually illustrates a login interface of the method and system for connecting knowledge seekers and subject matter experts, according to an aspect.

FIG. 7 conceptually illustrates a student profile interface of the method and system for connecting knowledge seekers and subject matter experts, according to an aspect.

FIG. 8 conceptually illustrates a subject matter expert profile interface of the method and system for connecting knowledge seekers and subject matter experts, according to an aspect.

FIG. 9 conceptually illustrates a subject matter expert preference interface of the method and system for connecting knowledge seekers and subject matter experts, according to an aspect.

FIG. 10 conceptually illustrates an available subject matter expert interface of the method and system for connecting knowledge seekers and subject matter experts, according to an aspect.

FIG. 11 conceptually illustrates a selected subject matter expert interface of the method and system for connecting knowledge seekers and subject matter experts, according to an aspect.

FIG. 12 conceptually illustrates a session interface of the method and system for connecting knowledge seekers and subject matter experts, according to an aspect.

FIG. 13 conceptually illustrates a completed session interface of the method and system for connecting knowledge seekers and subject matter experts, according to an aspect.

FIG. 14 conceptually illustrates a list of completed session interface of the method and system for connecting knowledge seekers and subject matter experts, according to an aspect.

FIG. 15 conceptually illustrates a completed session content interface of the method and system for connecting knowledge seekers and subject matter experts, according to an aspect.

FIG. 16 conceptually illustrates a completed session details interface of the method and system for connecting knowledge seekers and subject matter experts, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

As used herein and throughout this disclosure, the term “mobile device” refers to any electronic device capable of communicating across a mobile network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user's usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled elements across the figures (e.g., 110 and 210, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

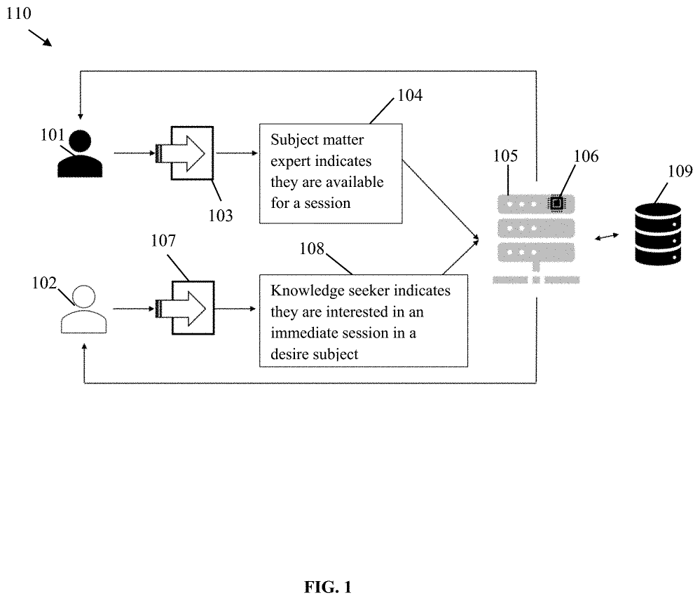

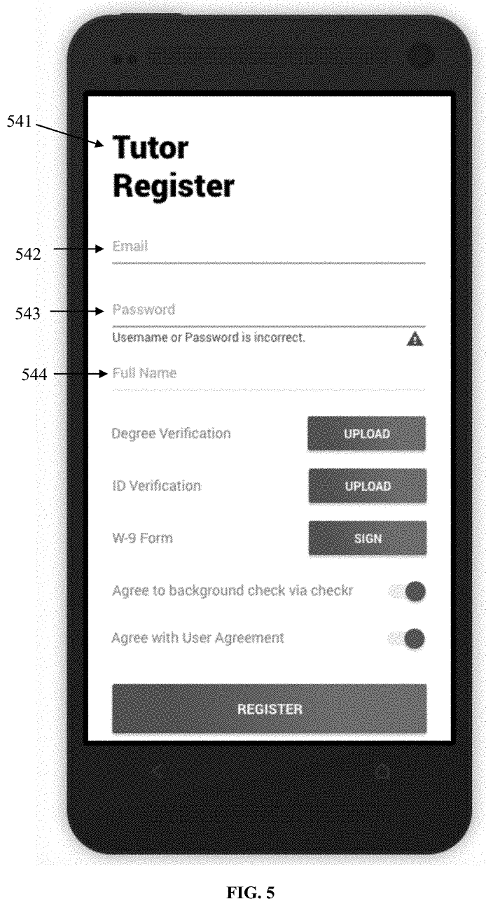

FIG. 1 illustrates a diagrammatic view of the user's experience while using the application 110 for prompt session connections, according to an aspect. As described herein, the user may be a knowledge seeker 102 or a subject matter expert (“subject expert,” “expert,” or “subject matter expert”) 101. The knowledge seeker may be a scholar, student, or any person seeking knowledge in a specific subject matter. The subject expert may be an educator, mechanic, cook, gardening expert, hobby expert, astronomy, author, model airplane expert, etc., or any person knowledgeable in a given subject. For example, trade specialist may be a subject expert for any person seeking knowledge in the specialist's area of expertise. The knowledge seeker 102 may login 107 to have access to an available subject matter expert for their desired subject, while the subject matter expert may login to teach the desired subject. The subject matter expert may be verified by uploading documents, which will be discussed in reference to FIG. 5.

The subject matter expert 101 may login 103 and once they login, the subject matter expert may indicate they are available for a learning session (“education session, tutoring session,” “session”) 104. This information from the server 105 is saved on the database 109. Simultaneously, a knowledge seeker 102 may login 107, and then the knowledge seeker 102 may indicate they are interested in immediate tutoring in a desired subject 108. In an example, the database 109 and server 105 may be a combined system. The server 105 may supply the data to the algorithm 106, which would match a knowledge seeker 102 and a subject matter expert 101 instantaneously and notify both the knowledge seeker 102 and subject matter expert 101 a session is ready to begin. The session may be a secure video call between the subject matter expert 101 and the knowledge seeker 102. The session may be for tutoring, homework help, information sharing, or a combination thereof. For example, the homework help session may be a thirty-minute session, while the education session may be an hour-long session. The session type may be chosen by the knowledge seeker as part of the expert request data.

For example, the data provided by the knowledge seeker and the subject matter expert may be saved in separate databases or separate sections of the database. In an example, the subject matter expert data is saved in one section of the database 109 or in a separate database, while the knowledge seeker data may be saved in the same database 109 in a different section, a second section, or a separate database.

Additionally, the application 110 for prompt session connections may be formatted for a mobile device. In another example, the application 110 for prompt session connections may be formatted for a webpage, which may be used on a computer. For example, the computer may be a desktop computer or a laptop computer. Furthermore, the mobile device may be a smart phone, which may allow the user to download the application 110 and have the video learning environment at any point and time. The application for prompt session connections 110 allows the knowledge seeker and learner and subject matter expert to input their desired outcome results in the algorithm 106, which allows the application to connect based on their individual education desires and preferences. With their desired outcome results saved in the server 105, the application may provide an immediate learning environment tailored to specific knowledge seeker and provided by a subject matter expert skilled in a specific desired subject.

Currently, individuals do not have immediate access to tutors specialized in teaching subject specific information within the individual learner's aptitude. The immediate connection between the knowledge seeker and the subject matter expert may be tailored specifically to each knowledge seeker. Additionally, students and their guardians typically must research each possible educational expert in an attempt to discover the best option for the student. However, these are not instant solutions, thus if the student needs immediate help, they have no options. Therefore, having an algorithm that may provide the knowledge seeker 102 with a certified subject matter expert promptly, while not requiring an appointment is needed.

For example, if a knowledge seeker 102 comes home and begins working on an assignment due the next day, but doesn't understand the concepts, the knowledge seeker may connect with a subject matter expert that night to go over the assignment. As described herein, the knowledge seeker may input desired subject matter, target budget, and education level into the subject matter expert preference interface, which saves the data to the server 105. Once the knowledge seeker 102 inputs their desired subject matter expert qualifications they may be provided with a list of currently available experts 101. After the knowledge seeker 102 selects their preferred subject matter expert the knowledge seeker 102 and subject matter expert 101 are brought to confined video conference experience based on each input.

The algorithm 106 may allow for knowledge seeker 102 to input their educational desires based on learning preferences. Once the knowledge seeker 102 has inputted their desired qualifications the algorithm may be initiated to check for available experts 101 that meet the standards set by the knowledge seeker coinciding with the experts' capabilities. After the knowledge seeker 102 inputs their desired subject matter, the knowledge seeker 102 would have the available experts shown with their qualifications and the knowledge seeker 102 may then select their preferred available subject matter expert and a session, such as a video conference, may begin. For example, one of the requirements may be the application having the option for the user to have specific learning methods combined with teaching methods to provide perfect learning experience between both entities. Moreover, the learner may have their entire experience recorded for review later. This may be beneficial to the learner to have access to because it may allow the learner to repeatedly go over more difficult concepts, they had sessions for. Furthermore, the expert may not have access to those recordings because the expert is only within the experience during the session.

Moreover, the user may download the application and once the download is complete the user may be asked to sign in, for example, using a Google or Facebook account. The user may also make an account within the application itself using their personal email. Once the user is signed in, they may be asked a series of questions, such as their education level, learning preference, teaching preference, and institution's name.

As described herein, the computer system promptly connects a knowledge seeker to a subject matter expert. The computer system having: a database 109 having a first section adapted to receive and store data associated with the knowledge seeker 102 and a second section adapted to receive and store data associated with the subject matter expert 101; a server 105 having a processor, operating system, memory, and an application 106 for promptly connecting the knowledge seeker to the subject matter expert comprising processor-executable instructions stored on a non-transitory processor-readable medium that when executed by the processor enables the computer system to perform operations. The application 106 having the steps of receiving and sending the data associated with the knowledge seeker and data associated with the subject matter expert to the database; wherein the data associated with the knowledge seeker comprises profile data provided by the knowledge seeker when registering with the application and expert request data including subject matter, target budget, and desired qualifications of the subject matter expert; wherein data associated with the subject matter expert comprises profile data provided by the subject matter expert when registering with the application including qualifications and government issued identification; checking in real time the background of the subject matter expert after receiving the government issued identification; confirming the identity of the subject matter expert by a live demonstration using a camera of a mobile device of the subject matter expert; setting a service fee per unit of time for the subject matter expert based on the subject matter expert's qualifications. The application 106 further having the steps of after receiving the expert request data from the knowledge seeker, matching the expert request data to the profile data of the subject matter expert who are logged in at that time; displaying at least one or more profiles of matching subject matter experts to the knowledge seeker; allowing the knowledge seeker to select a desired subject matter expert from the displayed subject matter experts; connecting the knowledge seeker to the subject matter expert in a secure session call; and recording the session between the knowledge seeker and the subject matter expert for future reference.

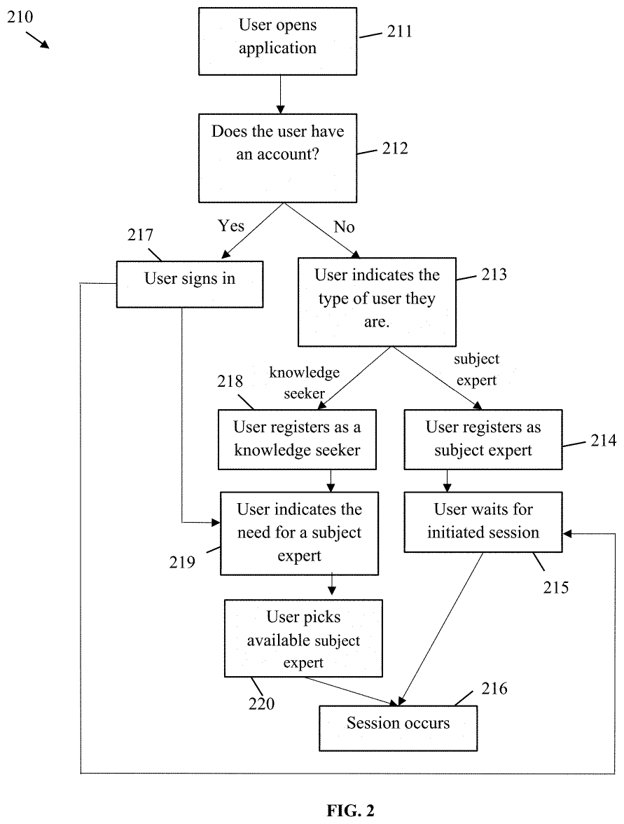

FIG. 2 illustrates the application's initiation flow chart, according to an aspect. As shown in the flow chart in FIG. 2, the user may begin by opening the application 211. Once the user opens the application, they may be asked if they have an account 212. If the user has an account, they may be asked to sign in 217, and if the user does not have an account, they may be asked to indicate what kind of user they are 213. If the user is a student 218, they would register as a student and indicated their need for a subject matter expert 219. The knowledge seeker may then pick an available subject matter expert 220 and initiate tutoring session 216. If the user indicated they are a tutor, they would register as a subject matter expert 214. For example, when registering as a subject matter expert the user may need to provide a copy of their degree and credentials to verify their qualifications. The subject matter expert's qualifications may include their degree, teaching credentials, and overall experience.

Once the user registers as an expert, the subject matter expert waits for an initiated session 215 with a knowledge seeker. As the subject matter expert logs in, the algorithm 210 adjusts the tutor's status to available. After the user has registered their first time the user has the option to sign in 217. The user may indicate if they have a need for a subject matter expert 219 or are a subject matter expert waiting for an initiated tutoring session 215. After the user has indicated their desired outcome the session may begin 216. The described algorithm 210 may allow for the almost immediate connection between a student and a subject matter expert. Additionally, this may allow for the knowledge seeker to always have access to a verified subject matter expert (which will be described in more detail when referring to FIG. 5) even at incontinent times, for example, late at night the night before an exam.

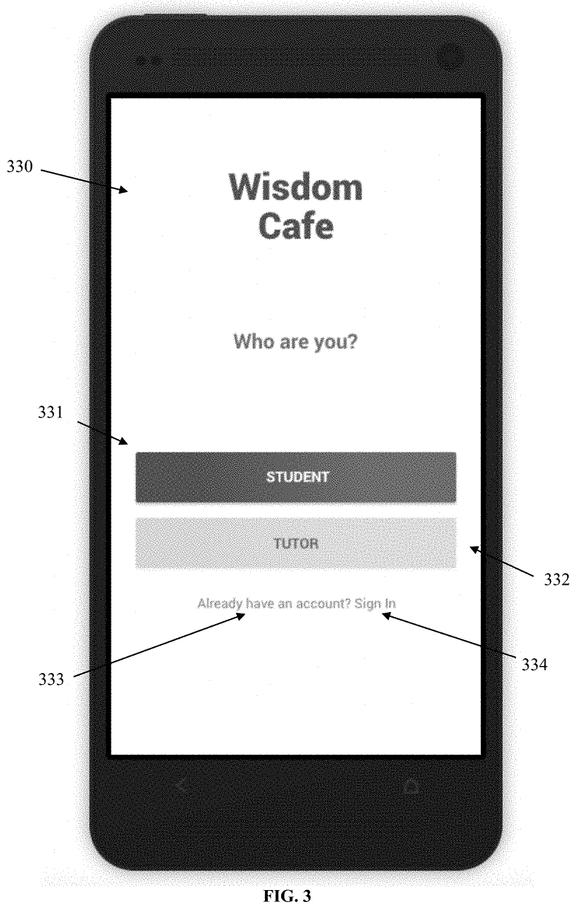

FIG. 3 conceptually illustrates a user welcome interface of the method and system for connecting knowledge seekers and subject matter experts, according to an aspect. For example, after the user downloads and opens the application, the user may be taken to the welcome screen 330. The welcome screen 330 may ask the user if they are a student 331 or subject matter expert 332. The welcome screen 330 may also ask if the user has an existing account 333, and if the user has an existing account the application may ask the user to sign in 334.

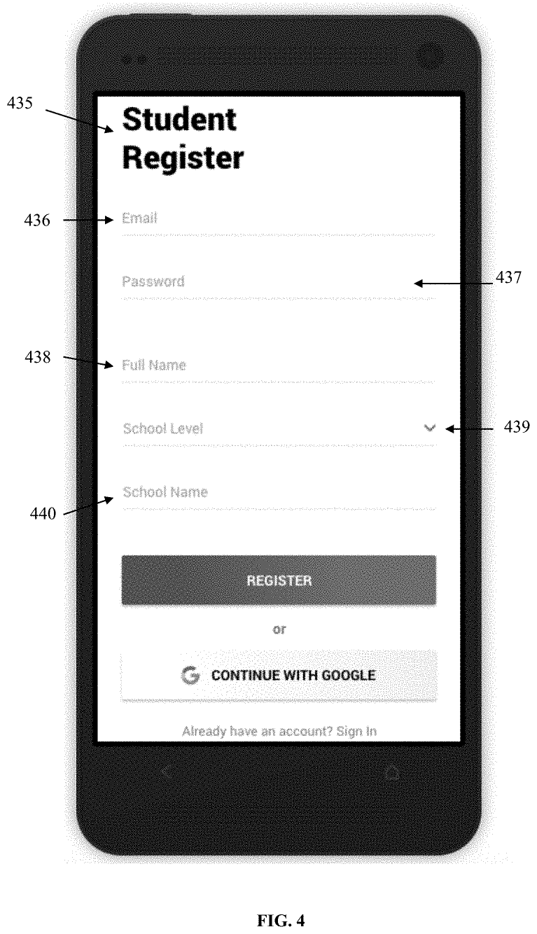

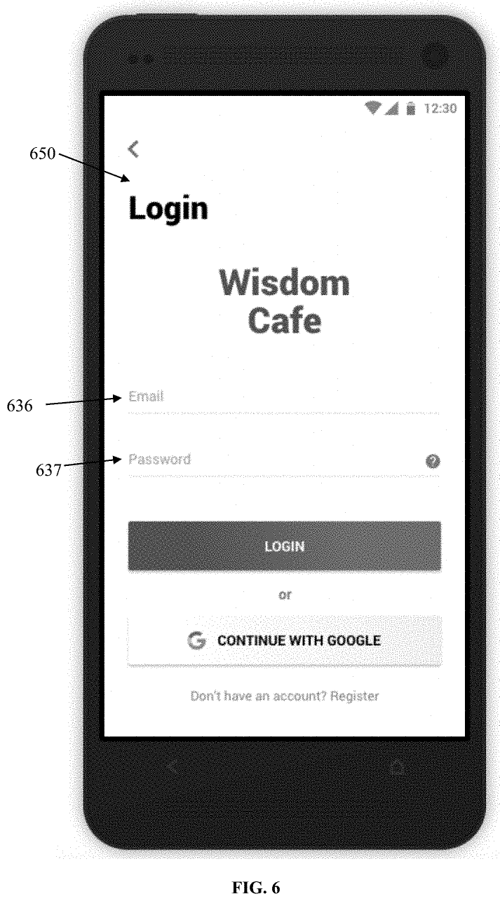

FIG. 4 conceptually illustrates a student registration interface 435 of the method and system for connecting knowledge seekers and subject matter experts, according to an aspect. The student registration interface 435 may request the knowledge seeker to input their email 436, name 438, education level 439, and educational institution 440. In an example, the school level selection 439 may be a drop-down menu with a list of education levels for the user to choose from. The student registration interface 435 may also request the user to provide a password 437 for future login purposes, which will be discussed in reference to FIG. 6. In an example, the user may sign in with their personal google account to provide the necessary information.

FIG. 5 conceptually illustrates a subject matter expert registration interface 541 of the method and system for connecting knowledge seekers and subject matter experts, according to an aspect. The subject matter expert registration interface 541 may request the subject matter expert to input their email 542 and full name 544. The subject matter expert registration interface 541 may also request the user to provide a password 543 for future login purposes, which will be discussed in reference to FIG. 6. In an example, the user may sign in with their personal google account to provide the necessary information.

Additionally, the subject matter expert registration interface may have upload links for the subject matter expert to provide their personal documents, such as their diploma, government photo identification, and W-9 form. For example, the subject matter expert may provide their personal documents by scanning the documents, taking a picture of them, or by inputting the information within an editable PDF displayed in a mobile format. The uploading of such documents allows the system to store the data and then to perform a background check on the subject matter experts. For example, the subject matter expert may receive their background check in real time. A background checking service, such as checkr or Shufti-Pro may be used to verify the subject matter expert's information and background. The background check may be done in real time, and, for example, the results may be emailed to the subject matter expert. Once the subject matter expert has passed their background check their profile may be live, which displays the subject matter expert as an available tutor. Verifying the subject matter expert's information allows each expert to be a reliable user and confirms they are the person they claim to be.

Moreover, the subject matter experts may be verified by a biometric verification using the government identification. The subject matter expert may have their identity confirmed by a live demonstration of their person by using the camera on the mobile device, such as a live proof and not a still image that has been uploaded. For example, the subject matter expert may be prompted by the application to have their camera on their mobile device held facing towards their face. The live demonstration captured by the subject matter expert's camera may then be verified against the provided government photo identification.

In an example, subject matter experts may be teachers from a specific school district, which may match with students of that school district. This may allow the connection between the knowledge seeker and subject matter expert to be better catered to the knowledge seekers' needs, such as knowing the standards of the school district and teaching methods of that school district. In another example, the knowledge seeker may receive the necessary knowledge from an AI machine learning system, which may have gathered data from the recorded session.

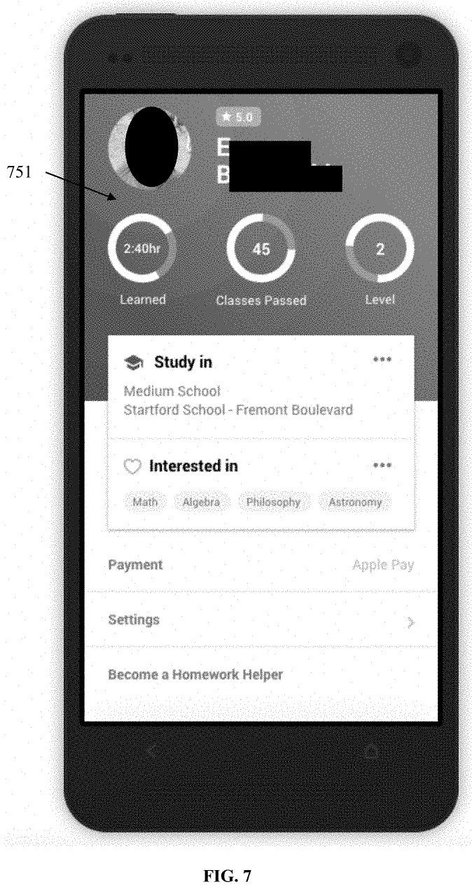

FIG. 6 conceptually illustrates a login interface 650 of the method and system for connecting knowledge seekers and subject matter experts, according to an aspect. The login interface 650 would prompt the user to input their email 636, or username, and password 637 to gain access to the application. Having a login interface also allows the knowledge seeker to have all their sessions to be saved. FIG. 7 conceptually illustrates a student profile interface 751 of the method and system for connecting knowledge seekers and subject matter experts, according to an aspect. The student profile interface, as shown, may have the knowledge seeker's profile data.

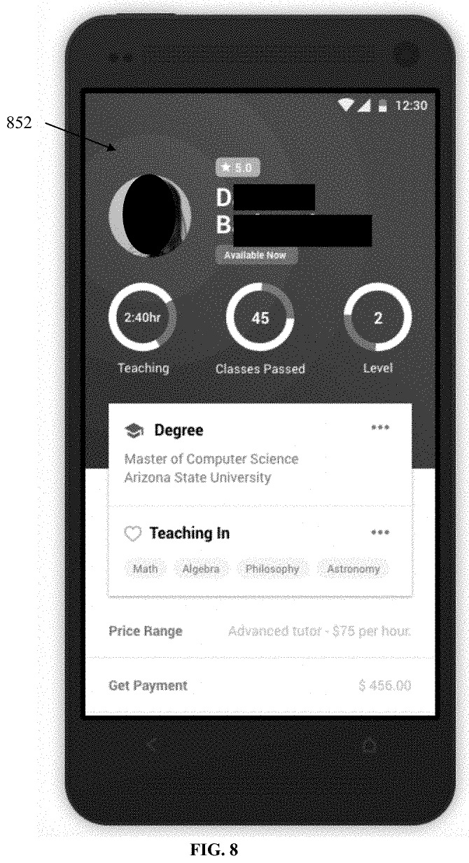

FIG. 8 conceptually illustrates a subject matter expert profile interface 852 of the method and system for connecting knowledge seekers and subject matter experts, according to an aspect. The subject matter expert profile interface 852, as shown, may have the subject matter expert user's credentials and education displayed. Additionally, the subject matter expert profile interface 852 may display the number of sessions they have had, the subjects they are experts in, and a rating they have received from other knowledge seekers based on their session quality. As described herein, the subject matter experts may be rated and reviewed, and may have their teaching styles integrated into their profile and review method.

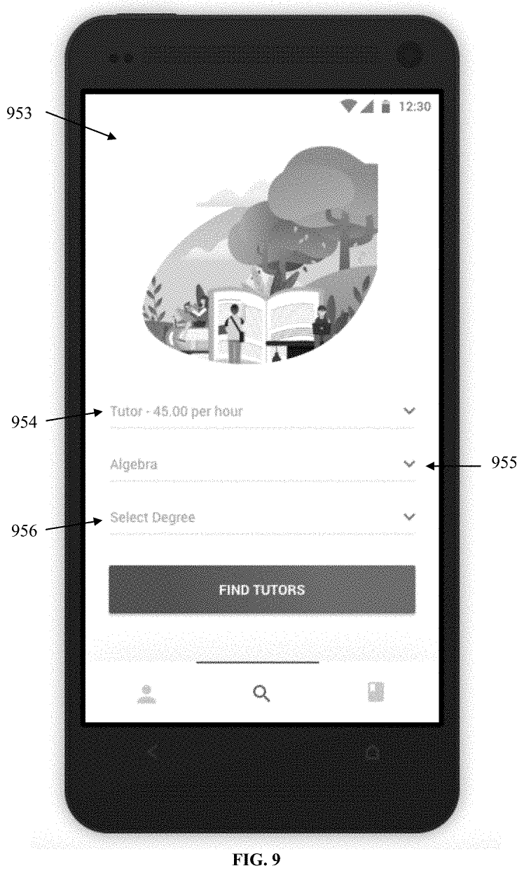

FIG. 9 conceptually illustrates a subject matter expert preference interface 953 of the method and system for connecting knowledge seekers and subject matter experts, according to an aspect. When the knowledge seeker is seeking an expert, an interface as shown by FIG. 9 may be displayed with the expert request data including subject matter, target budget, and desired credentials of the subject matter expert. For example, the subject matter expert preference interface 953 may prompt the knowledge seeker to disclose their target budget 954, the subject matter 955, and the desired degree or credentials 956 the subject matter expert must have. The subject matter expert preference interface 953 allows the student to be connected with a subject matter expert that meets all of their necessary qualifications. Additionally, the subject matter expert preference interface 953 narrows the pool of available subject matter expert to only the qualified experts based on the knowledge seeker's input.

In an example, the knowledge seeker may also request a specific location for the tutoring session to better understand a topic. As an example, the knowledge seeker may request a subject matter expert in Gettysburg where the knowledge seeker may see the area and battlefield during the tutoring session.

Furthermore, the application may determine the price for the subject matter expert. The service fee per unit of time of the session may be determined based on factors such as degree, credentials, and time of day. For example, if the subject matter expert has their teaching credentials, they may receive $35 an hour for the education session. In another example, if the subject matter expert does not have their teaching credentials, they may receive $12.50 for the thirty-minute homework help session. Additionally, the subject matter expert who does have their teaching credentials may also be available for homework help sessions and be paid a set rate.

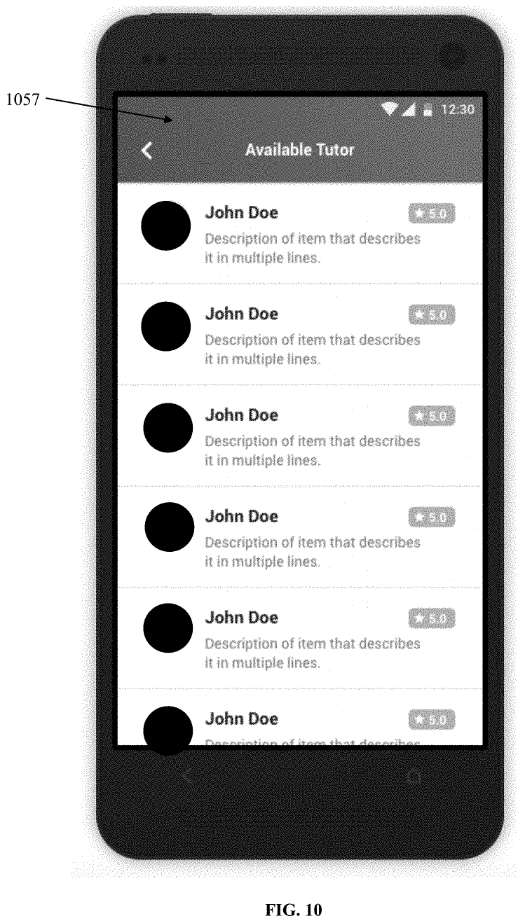

FIG. 10 conceptually illustrates an available subject matter expert interface 1057 of the method and system for connecting knowledge seekers and subject matter experts, according to an aspect. Once the knowledge seeker inputs their desired qualifications, they may be taken to an available subject matter expert interface 1057, as shown by FIG. 10. The available subject matter expert interface 1057 may allow the knowledge seeker to browse the available experts and pick, which would be best for their needs. For example, the available subject matter expert interface 1057 may show the available subject matter expert along with a description about the expert.

In an example, the knowledge seeker may be seeking help with complex math, but the application of the math may be in engineering. The available subject matter expert interface 1057 may allow the knowledge seeker to view available experts with complex math credentials, but the descriptions would allow the knowledge seeker to see there is an available subject matter expert with a background in engineering also. This may allow the knowledge seeker to have a more productive tutoring session because it helps with learning the concepts and their application.

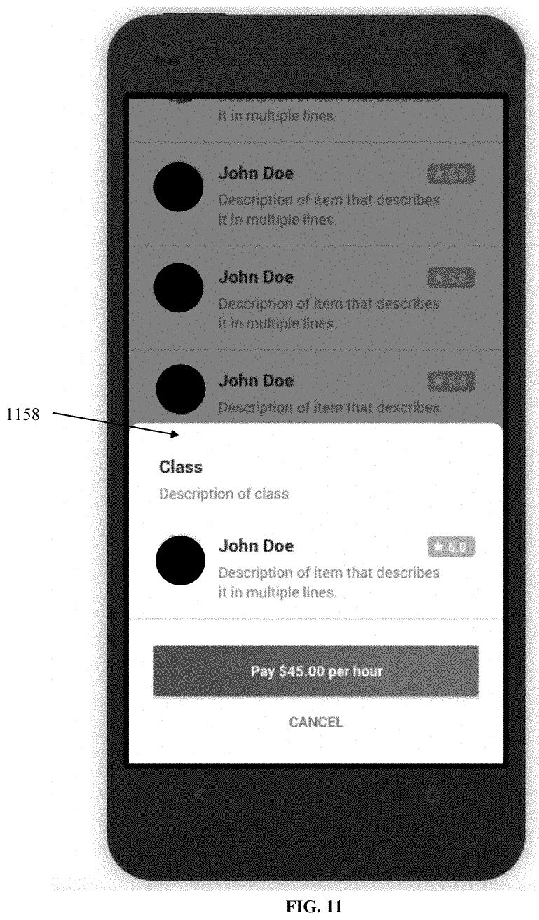

FIG. 11 conceptually illustrates a selected subject matter expert interface 1158 of the method and system for connecting knowledge seekers and subject matter experts, according to an aspect. After the knowledge seeker selected a desired subject matter expert they may be asked to confirm or pay the fee upfront as shown by FIG. 11. The knowledge seeker may not need to schedule an appointment, which allows the application to be accessible at any time of day when the knowledge seeker needs a tutor.

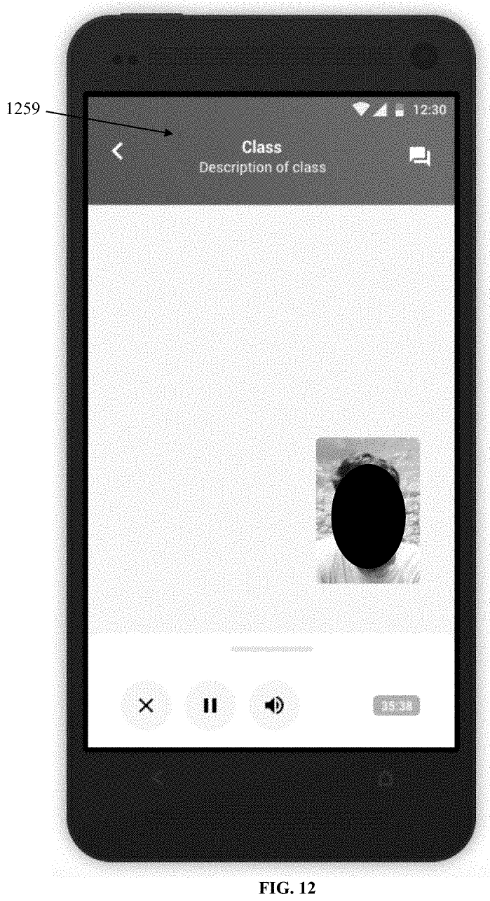

FIG. 12 conceptually illustrates a session interface 1259 of the method and system for connecting knowledge seekers and subject matter experts, according to an aspect. The session interface 1259 may allow both the student and subject matter expert users a video connection. In another example, the student and subject matter expert users may just have an audio connection, which would be dependent on the knowledge seeker's learning preference.

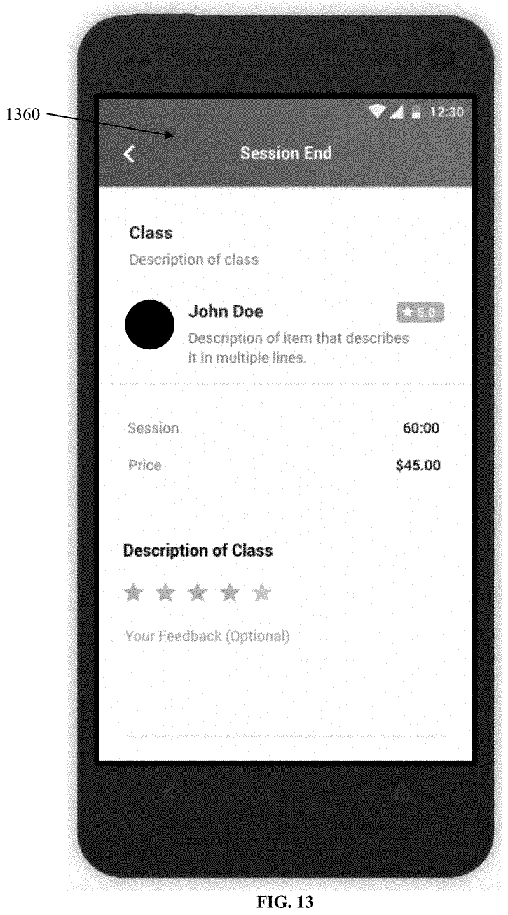

FIG. 13 conceptually illustrates a completed session interface 1360 of the method and system for connecting knowledge seekers and subject matter experts, according to an aspect. The completed session interface 1360 may allow the knowledge seeker to review the session's information. In an example, the completed session interface 1360 may have an option for the knowledge seeker to review and rate the session. Having the ability to review and rate each subject matter expert after a completed session may better help other knowledge seeker's make a more informed decision when choosing the best expert for them.

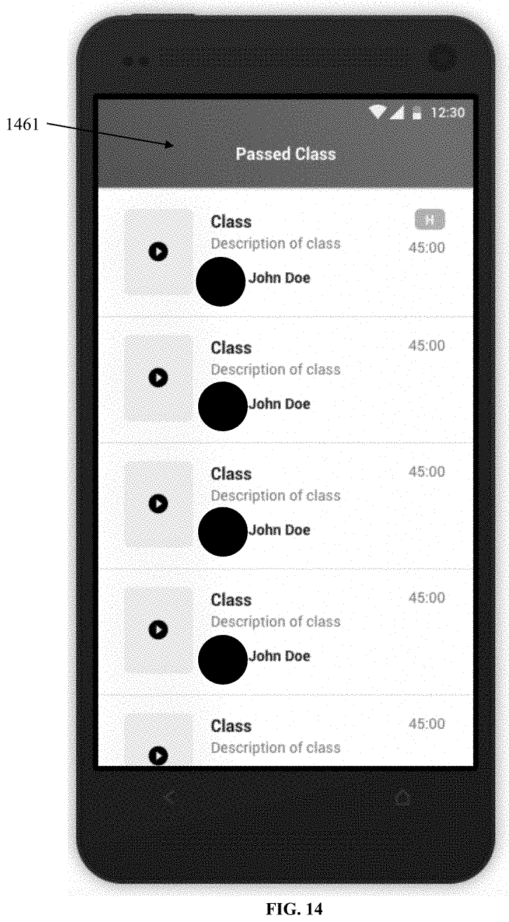

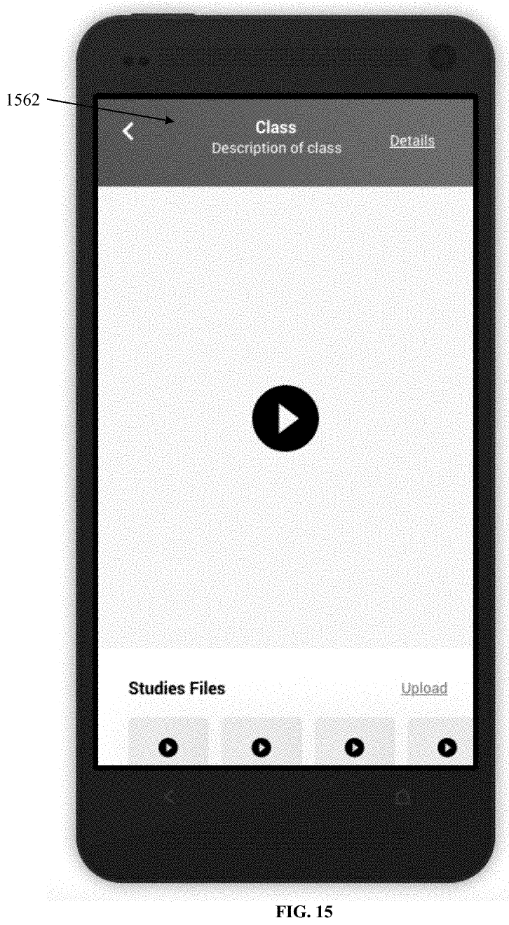

FIG. 14 conceptually illustrates a list of completed session interface 1461 of the method and system for connecting knowledge seekers and subject matter experts, according to an aspect. The list of completed session interface 1461 may allow each knowledge seeker to have a record of all their completed sessions. Additionally, FIG. 15 conceptually illustrates a completed session content interface 1562 of the method and system for connecting knowledge seekers and subject matter experts, according to an aspect. The completed session content interface 1562 allows the knowledge seeker to rewatch or listen to their previous sessions.

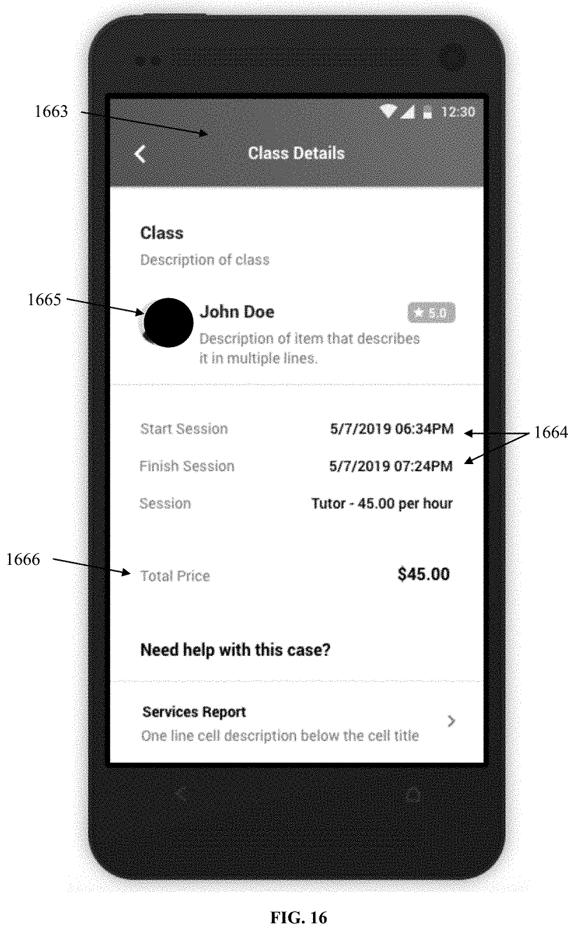

FIG. 16 conceptually illustrates a completed session details interface 1663 of the method and system for connecting knowledge seekers and subject matter experts, according to an aspect. The completed session details interface 1663 may display what day the session occurred, the beginning and end of the session 1664, the subject matter expert the knowledge seeker had 1665, and the cost 1666 of that session. Having the completed session details interface 1663 may allow the knowledge seeker to more easily navigate their past sessions. The completed session details interface 1663 also may allow the user to find the exact session they need to review.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A computer system for promptly connecting a knowledge seeker to a subject matter expert comprising:
a database having a first section adapted to receive and store data associated with the knowledge seeker and a second section adapted to receive and store data associated with the subject matter expert;
a server having a processor, operating system, memory, and an application for promptly connecting the knowledge seeker to the subject matter expert comprising processor-executable instructions stored on a non-transitory processor-readable medium that when executed by the processor enables the computer system to perform operations comprising:
receiving and sending the data associated with the knowledge seeker and data associated with the subject matter expert to the database;
wherein the data associated with the knowledge seeker comprises profile data provided by the knowledge seeker when registering with the application and expert request data including subject matter, target budget, and desired qualifications of the subject matter expert;
wherein data associated with the subject matter expert comprises profile data provided by the subject matter expert when registering with the application including qualifications and government issued identification;
checking in real time the background of the subject matter expert after receiving the government issued identification;
confirming the identity of the subject matter expert by a live demonstration using a camera of a mobile device of the subject matter expert;
setting a service fee per unit of time for the subject matter expert based on the subject matter expert's qualifications;
after receiving the expert request data from the knowledge seeker, matching the expert request data to the profile data of the subject matter expert who are logged in at that time;
displaying at least one or more profiles of matching subject matter experts to the knowledge seeker;
allowing the knowledge seeker to select a desired subject matter expert from the displayed subject matter experts;
connecting the knowledge seeker to the subject matter expert in a secure session call; and
recording the secure session call between the knowledge seeker and the subject matter expert for future reference.

2. The computer system of claim 1, further comprising displaying the completed session calls to the knowledge seeker.

3. The computer system of claim 1, wherein the knowledge seeker is a student.

4. The computer system of claim 1, wherein the subject matter expert is a tutor.

5. The computer system of claim 1, wherein the profile data provided by the subject matter expert when registering with the application further includes a W-9 form.

6. The computer system of claim 1, further comprising receiving and sending a GPS location from the knowledge seeker and the subject matter expert to the database.

7. The computer system of claim 1, further allowing the knowledge seeker to review the recorded session.

8. The computer system of claim 6, wherein expert request data from the knowledge seeker includes the GPS location of the subject matter expert.

9. The computer system of claim 1, further comprising receiving teaching and learning preference data from the knowledge seeker and the subject matter expert.

10. A computer system for promptly connecting a knowledge seeker to a subject matter expert comprising:
a database having a first section adapted to receive and store data associated with the knowledge seeker and a second section adapted to receive and store data associated with the subject matter expert;
a server having a processor, operating system, memory, and an application for promptly connecting the knowledge seeker to the subject matter expert comprising processor-executable instructions stored on a non-transitory processor-readable medium that when executed by the processor enables the computer system to perform operations comprising:
receiving and sending the data associated with the knowledge seeker and data associated with the subject matter expert to the database;
wherein the data associated with the knowledge seeker comprises profile data provided by the knowledge seeker when registering with the application and expert request data including subject matter, target budget, and desired qualifications of the subject matter expert;
wherein data associated with the subject matter expert comprises profile data provided by the subject matter expert when registering with the application including qualifications and government issued identification;
checking in real time the background of the subject matter expert after receiving the government issued identification;
confirming the identity of the subject matter expert by a live demonstration using a camera of a computer of the subject matter expert;
setting a service fee per unit of time for the subject matter expert based on the subject matter expert's qualifications;
after receiving the expert request data from the knowledge seeker, matching the expert request data to the profile data of the subject matter expert who are logged in at that time;
displaying at least one or more profiles of matching subject matter experts to the knowledge seeker;
allowing the knowledge seeker to select a desired subject matter expert from the displayed subject matter experts; and
connecting the knowledge seeker to the subject matter expert in a secure session call.

11. The computer system of claim 10, further comprising recording the secure session call between the knowledge seeker and the subject matter expert for future reference.

12. The computer system of claim 10, wherein the secure session call between the knowledge seeker and subject matter expert is a video call.

13. The computer system of claim 10, wherein the computer is a laptop computer.

14. The computer system of claim 10, wherein the computer is a desktop computer.

15. The computer system of claim 1, wherein expert request data from the knowledge seeker includes a learning preference of the knowledge seeker.

16. A method for immediately connecting a knowledge seeker to a subject matter expert comprising the steps of:
receiving and sending the data associated with the knowledge seeker and data associated with the subject matter expert to the database;
wherein the data associated with the knowledge seeker comprises profile data provided by the knowledge seeker when registering with the application and expert request data including subject matter, target budget, and desired qualifications of the subject matter expert;
wherein data associated with the subject matter expert comprises profile data provided by the subject matter expert when registering with the application including qualifications and government issued identification;
checking in real time the background of the subject matter expert after receiving the government issued identification;
confirming the identity of the subject matter expert by a live demonstration using a camera of a mobile device of the subject matter expert;
setting a service fee per unit of time for the subject matter expert based on the subject matter expert's qualifications;
after receiving the expert request data from the knowledge seeker, matching the expert request data to the profile data of the subject matter expert who are logged in at that time;
displaying at least one or more profiles of matching subject matter experts to the knowledge seeker;
allowing the knowledge seeker to select a desired subject matter expert from the displayed subject matter experts;
connecting the knowledge seeker to the subject matter expert in a secure session call; and
recording the session between the knowledge seeker and the subject matter expert for future reference.

17. The method of claim 17, further comprising displaying the completed secure session calls to the knowledge seeker.

18. The method of claim 17, further allowing the knowledge seeker to review the recorded session.
